(19) United States
(12) Patent Application Publication
(10) Pub. No.: US 2008/0183829 A1
(43) Pub. Date: Jul. 31, 2008

(54) Debating Website with Voting

(76) Inventors: Shrage Smilowitz, Monroe, NY (US); Malcolm S. Meyers, London (GB)

Correspondence Address: DIEHL SERVILLA LLC, 77 BRANT AVE, SUITE 210, CLARK, NJ, 07066, US

(21) Appl. No.: 12/019,154

(22) Filed: Jan. 24, 2008

Related U.S. Application Data
(60) Provisional application No. 60/886,682, filed on Jan. 26, 2007.

(51) Int. Cl. G06F 15/16

(52) U.S. Cl. 709/206

(57) ABSTRACT

Methods and a system for online debating are disclosed. Providing a presentation of a debate over the Internet to a user is also disclosed. A debate can be provided to an end user as a single or as multiple web pages. Providing a user with interactive capability on a web page to rate a debate and debaters has been disclosed. Organizing debates as an online game is also disclosed. Statistical information on debaters and debates can be used by a user to predict debater performance as a bet.

### CROSS-REFERENCE TO RELATED APPLICATIONS

This application claims priority under 35 U.S.C. §119(e) to U.S. Provisional Patent Application Ser. No. 60/886,682, filed as Jan. 26, 2007 which is incorporated herein in its entirety by reference.

### BACKGROUND OF THE INVENTION

The present invention relates to a method and system for conducting, moderating and deciding debates between opponents. More in particular it relates to presenting a debate on a website and having the outcome of the debate decided by users connected to the website.

A debate between opponents can have significant entertainment value. Audiences to a debate may be highly interested in the debate. They may be interested because of the issues being debated. Often people are also interested because of entertainment factors such as the character of the debating opponents, their attitude, personal appeal, use of humorous arguments, etc. In many cases audiences have a preference for one of the opponents. Public debates are often analyzed on television by, for instance, political commentators. In many cases people watching these analyses have different opinions on the performance of debaters than the analysts. In many cases there is limited opportunity for audiences of a debate to vote for the debaters and to rate their performance.

Accordingly, easy and entertaining methods and systems are required that provide audiences with the capability to influence a decision who won a debate and to provide a rating of the performance of the debaters.

### SUMMARY OF THE INVENTION

In accordance with one aspect of the present invention, novel methods and systems are provided for debating as an online game with interactive participation by an audience of a debate.

In accordance with another aspect of the present invention a method is provided comprising, organizing a debate by an organizer; providing at least two debaters; allotting a debater an amount of time for presenting an opinion; allotting a debater an amount of time to rebuttal; presenting the opinion of a debater by transmitting an electronic signal on a network; enabling a user to access the electronic signal; enabling the user to provide a rating to the organizer of a debater; and providing an end rating on a debater by the organizer.

In accordance with a further aspect of the present invention a method is provided further comprising providing rules for conducting the debates; and moderating the debate according to the rules by a moderator.

In accordance with another aspect of the present invention a method is provided further comprising controlling the electronic signal by a moderator.

In accordance with a further aspect of the present invention a method is provided further comprising generating a plurality of different electronic signals which can be presented on different web pages by a user, wherein each web page is characterized by a different Uniform Resource Locator (URL).

In accordance with another aspect of the present invention a method is provided further comprising awarding a debater points by the organizer.

In accordance with a further aspect of the present invention a method is provided further comprising providing on a web page statistical information on debating performance of a debater.

In accordance with another aspect of the present invention a method is provided further comprising enabling a user of a web page to predict a rating of a debater in a debate.

In accordance with a further aspect of the present invention a method is provided wherein the user makes a bet.

In accordance with another aspect of the present invention a method is provided further comprising: enabling a user of a web page to provide a comment to the organizer.

In accordance with a further aspect of the present invention a method is provided wherein the electronic signal comprises an audio signal.

In accordance with another aspect of the present invention a method is provided wherein the electronic signal comprises a video signal.

In accordance with a further aspect of the present invention a method is provided wherein the electronic signal comprises a text signal.

In accordance with another aspect of the present invention a method is provided wherein the end rating by the organizer is an aggregate of ratings provided by users.

In accordance with a further aspect of the present invention a method is provided wherein a subject for debate is provided by the organizer.

In accordance with another aspect of the present invention a method is provided wherein a subject for debate is provided by a user of a web page.

### DESCRIPTION OF THE DRAWINGS

FIG. 1 illustrates a system for presenting a debate online.

FIG. 2 illustrates a method for presenting at least two debaters.

FIG. 3 illustrates another method for presenting at least two debaters.

FIG. 4 illustrates a single user having access to a single web page for following an online debate.

FIG. 5 illustrates a single user having access to multiple web pages for following an online debate and to provide information interactively.

### DESCRIPTION OF A PREFERRED EMBODIMENT

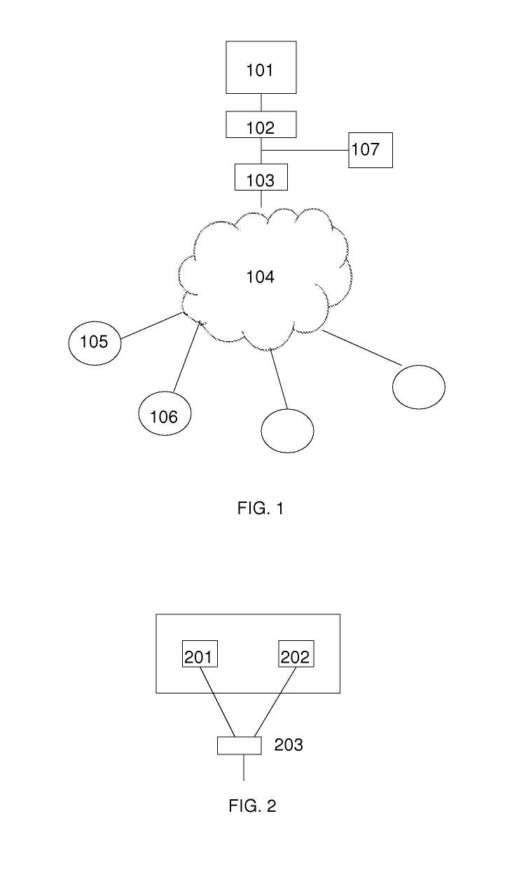

As one aspect of the present invention a debate between opponents is organized and provided via a server over the internet to an audience of users. This is shown in a diagram in FIG. 1. Herein at least two debaters are in a facility 101 wherein a debate is registered as a sound and/or a video signal or any other form that can be registered and recorded or transmitted as an electronic signal. There may or may not also be a judge or moderator 102, having the ability to control the transmission of the debate to a network.

Such a network is shown as 104 in FIG. 1, which can be the Internet. The signal provided from the debate or the moderator is entered into a server 103 which will put the signal into an appropriate format. For instance, a debate may be viewed by online users, who will connect to the server 103 also over the Internet. Accordingly, before being sent on the Internet the format of the signal has to be created in such a form that it can be sent over the Internet, received by users and viewed on a device, for instance, a computer or a mobile device, for instance, by using a web browser.

A plurality of users can view the debate at the same time. In FIG. 1 two users 105 and 106 are identified. They can watch the debate as it progresses, for instance, on their computer. The debate can be interrupted by the moderator 102. The moderator 102 may in actuality be a plurality of persons of which each controls an aspect of the debate or the transmission. There may be a final approver in 102 who has the final decision of what will be transmitted.

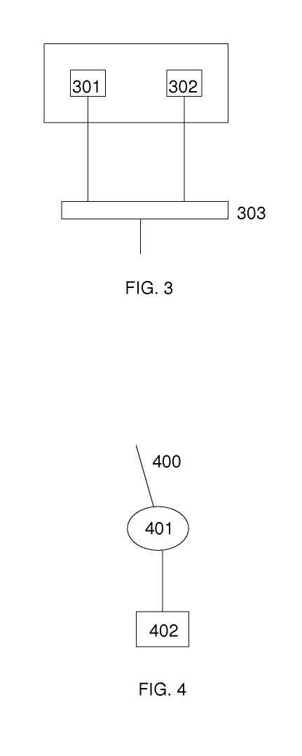

People participating as debaters may be in one facility or as shown in FIG. 2 they may be in different facilities for instance 201 and 202. The signals for transmission may be collected at a unit 203 before it is provided to a moderator. As shown in FIG. 3 the signals of different facilities 301 and 302 may also be transmitted individually to a moderator 303 who, like a director, decides which one will be transmitted. For instance the debater making an argument may be transmitted as a picture in a main window, while a picture of an opponent is transmitted in a second window. Because this is done over the Internet users may actually open multiple browsers. Accordingly, server 103 may transmit several pictures or signals that will provide information in different browser windows at a user's computer.

The organization and enablement of multiple windows requires a system unit 107 that will be able to instruct the server 103 to create multiple signals and insert the appropriate information. The system unit 107 may be completely or partially controlled by the moderator.

It is an aspect of the present invention to provide a certain status to a user of the system. Such a status for instance may depend on type of registration, potential payment, or other criteria. FIG. 4 illustrates one type of status. Herein a user 401 has access to only one website 402 generated by the system over for instance an Internet connection 400. Such a website 402 may comprise video of the debate showing for instance two debaters. The website may show within the page additional information like background information, or it may show for instance close-up shots of the debaters. This is then very much like, for instance, a single tv screen. It should be appreciated that a single webpage could also be organized as a radio station, providing audio of a debate, and including background information such as text, pictures or videos within the single page.

It should be appreciated that a debate can also be conducted in text, in which case the webpage displays, for instance, text as entered by the debaters.

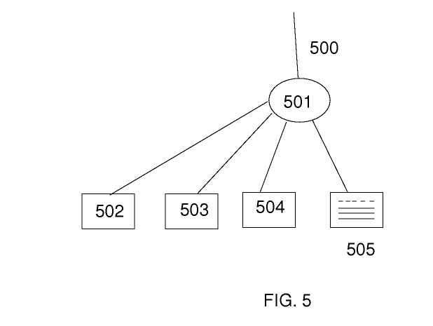

As is shown in diagram FIG. 5 it is also possible to display the progress and overview of the debate in multiple and independently opened web pages. In one embodiment, each web page may have a unique URL. FIG. 5 shows as an illustrative example how a user 501 through for instance an Internet connection 500 has access to the system, which provides a plurality of web pages 502, 503, and 504. Each web page may independently display progress or aspects of a debate.

Access to the plurality of web pages may depend on the level of registration by a user. For instance, no or simple registration may be allow access to a single overview screen. A higher level of registration may provide access to some or all of the additional pages. It is, of course, possible to provide users with access to all pages with no registration.

FIG. 5 also shows a means of access 505 by the user to the system, which may be a keyboard, a mouse, or any other tool interactive computer input device. This allows a user to for instance vote on the performance of the debaters. The system may generate before, during or after the debate registered and/or unregistered users to vote on the performance of the debaters.

For instance the organizer or moderator of the debate may, for instance, start a debate with a display or explanation of the subject of the debate. It may also provide background, including for instance video, text, or pictures of the debaters. After or during providing the information the organizers or moderators may ask users to vote on certain aspects of the debaters and the subject. For instance it may be asked which of the positions taken by debaters appear to be stronger; which of the debaters appear to be stronger and which of the debaters is most likely to win.

In a separate window of a screen, or on a separate page, the organizers of the debate may provide an opportunity to users to provide direct input, for instance through a typed message, on the debate, the debaters or the subjects to be debated. A moderator in control of this aspect of the system of the invention, may make available all or a selection of comments provided by users on a web page.

During the debate the questions provided by a moderator of the system may change to reflect a specific state of the debate.

The system may enable voting on a question during a limited time. It may take measures (for instance by registering the originating IP address of a vote) to disable voting after a vote was cast by a user, and enable voting again, after a new voting question was provided. Votes may be counted and the result displayed on a web page. The advantage of having users register is to collect information from a user such as gender, location, education or any other information that is deemed relevant. The result of a vote can be aggregated and displayed after the debate to determine a winner. It may also be displayed during the debate, and in that way, for instance, rate the progress of a debate and show how a rating on a debater or on his/her position may be changing. Statistical information on the distribution of votes may also be provided to the users.

Organizers of a debate may create a formula to determine how votes provided by users determine the winner of a debate. The winner of a debate may also be decided by a final vote of users on who the winner is.

The debate organizers may make a web page available before a debate which is interactive and allows registered or unregistered users to provide suggestions, for instance on debating topics and on debaters. Selected debaters for a debate may also select a subject for a debate.

The debate may be conducted as an online game. Each debater has an allotted time for each stage of the debate or, if the debate is conducted in text mode, an allotted number of words. The stages of the debate may include opening arguments by debaters, rebuttals or responses and closing arguments. The number of responses and allotted time may be limited. After a certain time the debate may close automatically from debating phase and go into voting phase, wherein voters may cast their vote for a debater or for any other subjects. The debater with the most votes may win the debate. A formula for calculating who the winner is may be applied.

A series of debates may be conducted using a similar format, and for instance organized in leagues or in tiers. Starting out with a group of debaters the purpose may be to have a championship contest wherein the two debaters having for instance the most wins will face each other for a champion title.

Each debater is rewarded a certain number of points after a debate. Based on their ratings, debaters may be divided into leagues, classes of medals won, trophies to debate for and won and accolades.

It is another aspect of the present invention to provide methods for users to predict and bet on potential winners of debates. Statistics of wins and losses of debaters, points collected and votes on individual performances may be made available to registered or unregistered users, allowing for a user to make a statistical prediction on future performance of a debater.

Accordingly, a debate may range from a text-based, perhaps single-window online user-interactive event, to a fully-moderated, video and multi-media using, multi-screen, user-interactive production.

The format of a debate presentation may use specific browser interfaces that may be provided as specific websites, browser plug-ins or computer applications.

Judges and moderators on the system may contribute to the quality and entertainment value of a debate. Moderators may be designated from a group of moderators by the organizer of a debate or pre-selected for a specific debate, they may also be selected by debaters from a group of designated moderators.

The term debater is applied herein as a party in a debate taking and defending a position on a subject. A debater may be a single person or a group of persons. A group of persons may assign one person per debate to represent a group. Also different persons of the group may present a position or respond in a rebuttal during a debate.

In accordance with another aspect of the present invention, a system for online debating on the Internet is provided. The system includes, at least, a website at a first location on the Internet, a first remote computer and a second remote computer. An opinion of a first debater is displayed on the first remote computer by transmitting a first electronic signal from the website on the Internet, a rebuttal opinion of a second debater is displayed on the first remote computer by transmitting a second electronic signal from the website on the Internet, and a user on the second remote computer can provide one or more comments on the opinion or the rebuttal to the website over the Internet.

In accordance with a further aspect of the present invention, the user can provide a vote on whether the opinion or the rebuttal opinion won. The system can also include one or more additional remote computers wherein users can provide a vote and wherein the website displays results of the votes on the web site. Thus, a plurality of users can view the debate and provide comments on the debate.

In accordance with another aspect of the present invention, the one or more comments by the user regarding the opinion or the rebuttal are provided to the website and then transmitted over the Internet to the first remote computer and the comments are displayed on the first computer. Thus, third parties are allowed to participate in the debate and to see what others think about the debate.

The opinion and the rebuttal opinion can be displayed on the first remote computer at the same time. Further, the opinion, the rebuttal opinion and the one or more comments are displayed on the first remote computer at the same time. Also, the opinion or the rebuttal opinion and the one or more comments are displayed on the first remote computer at the same time.

The system can also include one or more additional remote computers wherein users can provide comments on the opinion or the rebuttal opinion to the website over the Internet.

Information relating to the opinion can include text, graphics, video information, audio information and/or hyperlinks. Thus, the first electronic signal can include all of these types of information. Similarly, information relating to the rebuttal opinion can also include text, graphics, video information, audio information and/or hyperlinks to other websites. Further, the comments provided can also include all of this information.

The system can also include a third remote computer on which the opinion is provided over the Internet to the website and a fourth remote computer over which the rebuttal opinion is provided over the Internet. The system, however, is not limited to any set number of remote computers, as many third party users can view the debate and participate by providing comments and votes.

The website, in accordance with a further aspect of the present invention, can also provide a timed period in which the opinion and the rebuttal opinion must be provided. After the expiration of the timed period, any further presentation of the opinion or the rebuttal opinion is stopped by the website. Further, sur-rebuttal opinions may be provided, thereby allowing a response to the rebuttal opinion. Further, responses can also be provided by the system of the present invention.

In accordance with a further aspect of the present invention the website may provide a user the opportunity to become a debater in a debate on a website. The user may have to be a registered user. The user may select a subject from a list to debate. The user may also provide his or her own subject to debate.

In accordance with another aspect of the present invention the website may publish a challenge for debate and invite opponents to engage in debate. The debate may also be arranged between opponents. Opponents may be selected from a list available to the system. Criteria for selection may be provided by an organizer.

In one embodiment, debaters register at a website as available debaters. Debaters may be required to submit information which may be used in being accepted as a debating opponent. A list of debaters may be available on a website. Background information may be published as part of a listed debater's listing.

An organizer of a debate, and listed on a list of debaters, may challenge another listed debater to a debate. A challenge to debate may comprise a subject to debate and a brief description of the subject. A debate subject may be selected from a list provided by a website. The challenged debater may accept to engage in a debate. He or she may also decline to engage in debate. A decline or acceptance of debate may be based on the subject or on information listed. It may also be based on background information of the challenging debater.

An organizer of a debate may invite registered debaters to engage in debate on a website. A listed debater may respond to the invitation. A challenger may reject a responding debater as opponent.

A system may connect debaters for debate. A debater connected for debate by a system may reject such a debate. The system may have a limitation on the number of rejections that a debater can make.

In accordance with a further aspect of the present invention opponents have to provide an opening statement or argument. Such an opening statement may be in text, and may be limited in size, for instance in number of words or number of characters. An opening statement may also be an audio or video signal, wherein the duration of such signal may be limited. Opening statements either in text or in audio or video will be made available as a website to the public. A debater may be required to provide an opening statement within a certain time frame, for instance within 24 hours after start of a debate.

Each debater will be allowed at least one rebuttal to arguments made by a debating opponent. As in the case of the opening statements a rebuttal may have to comply with a size limitation in case of a text response or duration if the response is in audio or video. Rebuttals may be required to be provided within a certain time period. A rebuttal will also be published on a website.

During arguments users of the website may provide comments to the website. These comments will be collected, and may be published on the website. In accordance with another aspect of the present invention, the comments will be published after a debate is finalized.

In accordance with a further aspect of the present invention, debater and opponents may be allowed a closing argument, again having to comply with limitations of duration and or size, and may have to be delivered within a time limit.

In accordance with another aspect of the present invention, more than two debaters may be engaged in a debate, having to comply with rules of size, duration and time of response.

In accordance with a further aspect of the present invention, a server or a plurality of servers providing the website may enable a plurality of website based debates.

Determining a winner of a debate and the relative position of a debate in a series of debates with different debaters may be conducted automatically by a system. The system may enable an opportunity for voting online by users after or during a debate for one or more debaters. This enablement may last for only a limited time. The system records the votes for a debater and calculates automatically a winner of a debate after voting has been disabled. A system may also award a debater a number of points according to one or more rules after a debate. The system may combine the points earned by a debater in a current debate and previous debates. This may be used to determine the overall position of a debater relative to other debaters. In accordance with another aspect of the present invention, statistics of a debater may be published on a website, allowing online users to predict the performance of such a debater in a future debate. Users may be enabled to bet on future performance on a website.

In accordance with a further aspect of the present invention, a debate and all its related information will remain available on a website. Debates and related information may be searchable and viewable on a website. Debates and related information may be stored in an archive available on a website. Statistical information and comments are also available in the archives The archive is accessible on a website. The website archive may be searched on debater. It may also be searched on another criterion, for instance on subject of debate. This allows debaters to assess the performance of opponents. It also allows betters to try to predict future performance of a debater.

While there have been shown, described, and pointed out, fundamental novel features of the invention as applied to preferred embodiments thereof, it will be understood that various omissions and substitutions and changes in the form and details of the device illustrated and in its operation may be made by those skilled in the art without departing from the spirit of the invention. It is the intention, therefore, to be limited only as indicated by the scope of the claims appended hereto.

1. A method for online debating, comprising:
organizing a debate by an organizer;
providing at least two debaters;
allotting a first debater an amount of time for presenting an opinion;
allotting a second debater an amount of time to rebut;
presenting the opinion of a debater by transmitting an electronic signal on a network;
enabling a user to access the electronic signal;
enabling the user to provide a rating to the organizer of at least one of the debaters; and
providing an end rating on at least one of the debaters by the organizer.

2. The method as claimed in claim 1, further comprising:
providing rules for conducting the debate; and
moderating the debate according to the rules by a moderator.

3. The method as claimed in claim 1, further comprising:
awarding points to a debater by the organizer.

4. The method as claimed in claim 1, further comprising:
providing on a web page statistical information on debating performance of a debater.

5. The method as claimed in claim 1, further comprising:
enabling a user of a web page to predict a rating of a debater in a debate.

6. The method as claimed in claim 5, wherein the user makes a bet.

7. The method as claimed in claim 1, further comprising:
enabling a user of a web page to provide comment to the organizer.

8. The method as claimed in claim 1, wherein the electronic signal comprises one or more of an audio signal, a video signal and a text signal.

9. The method as claimed in claim 1, wherein the end rating by the organizer is an aggregate of ratings provided by users.

10. The method as claimed in claim 1, wherein a subject for debate is provided by one or more of the organizer or a user of a web page.

11. A method for online debating on an Internet from a website, comprising:
displaying an opinion of a first debater on a first remote computer by transmitting a first electronic signal from the website on the Internet;
displaying a rebuttal opinion of a second debater on the first remote computer by transmitting a second electronic signal from the website on the Internet;
allowing a user on a second remote computer to provide one or more comments on the opinion or the rebuttal to the website over the Internet.

12. The method as claimed in claim 11, wherein the user provides a vote on whether the opinion or the rebuttal opinion won.

13. The method as claimed in claim 11, comprising transmitting the one or more comments by the user regarding the opinion or the rebuttal over the Internet to the first remote computer and displaying the comments on the first computer.

14. The method as claimed in claim 11, wherein the first electronic signal, the second electronic signal and the comments can include text, graphics, video and audio information.

15. The method as claimed in claim 11, wherein one or more of the first electronic signal, the second electronic signal and the comments can include a hyperlink to another website.

16. A system for online debating on an Internet, comprising:
a website at a first location on the Internet;
a first remote computer;
a second remote computer;
wherein an opinion of a first debater is displayed on the first remote computer by transmitting a first electronic signal from the website on the Internet, a rebuttal opinion of a second debater is displayed on the first remote computer by transmitting a second electronic signal from the website on the Internet, and a user on the second remote computer can provide one or more comments on the opinion or the rebuttal to the website over the Internet.

17. The system as claimed in claim 16, wherein the user provides a vote on whether the opinion or the rebuttal opinion won.

18. The system as claimed in claim 17, comprising one or more additional remote computers wherein users can provide a vote and wherein the website displays results of the votes on the web site.

19. The system as claimed in claim 16, wherein the one or more comments by the user regarding the opinion or the rebuttal are transmitted over the Internet to the first remote computer and the comments are displayed on the first computer.

20. The system as claimed in claim 18, wherein one or more of the opinion and the rebuttal opinion are displayed on the first remote computer at the same time as the one or more comments.
